(19) United States
(12) Patent Application Publication
(10) Pub. No.: US 2015/0302515 A1
(43) Pub. Date: Oct. 22, 2015

(54) METHOD, APPARATUS, AND SYSTEM FOR SIMULATING OBJECTS

(71) Applicant: Alibaba Group Holding Limited, George Town (KY)

(72) Inventor: Zhining Li, Hangzhou (CN)

(21) Appl. No.: 14/689,840

(22) Filed: Apr. 17, 2015

(30) Foreign Application Priority Data
Apr. 21, 2014 (CN) 201410160767.0

(51) Int. Cl. G06Q 30/06; G06F 17/30

(52) U.S. Cl. CPC G06Q 30/0643; G06F 17/30867

(57) ABSTRACT

Embodiments of the present application relate to a method and system for operating simulation of an object. The method includes receiving, from a first user, a first request to operate a simulation, wherein the first request to operate the simulation has information associated therewith, the information associated with the first request to operate the simulation including an indication of an object, searching for a second user based at least in part on the information associated with the first request to operate the simulation, sending, to the second user, a second request to operate the simulation associated with the object, receiving, from the second user, a result of the simulation in accordance with the second request to operate the simulation, and sending, to the first user, the result of the simulation.

### CROSS REFERENCE TO OTHER APPLICATIONS

This application claims priority to People's Republic of China Patent Application No. 201410160767.0 entitled A METHOD, A DEVICE, AND A SYSTEM FOR BUSINESS OBJECT OPERATING SIMULATION, filed Apr. 21, 2014 which is incorporated herein by reference for all purposes.

### FIELD OF THE INVENTION

The present application relates to a field of simulation technology. In particular, the present application relates to a method for an operating simulation for objects, a device relating to an operating simulation for objects, and a system relating to an operating simulation for objects.

### BACKGROUND OF THE INVENTION

The number of Internet users is growing exponentially, and some industry websites have been further developed in recent years. In addition, the technical threshold associated with developing an industry website is lower than the technical threshold associated with developing a traditional brick-and-mortar business and requires less investment. Because of the relatively lower technical threshold and investment associated with building an industry website, a greater number of users have been building and operating industry websites.

Currently, each industry has unique objects (e.g., goods for sale). For example, the types of objects and features associated with a particular industry are generally relevant, or otherwise applicable to other industries. Although objects of entirely different types and features exist in different industries, currently, different objects on industry websites are generally described in the form of both images and text. As a result, users have difficulty performing operating simulations on objects provided on industry websites.

Currently, industry websites use two-dimensional or three-dimensional technologies for virtual simulation of objects. However, two-dimensional or three-dimensional technologies simulation testing requires specialized development of a set of simulation devices. The cost associated with such specialized development of the set of simulation devices is very high. In addition, such an operating simulation approach does not allow users to directly experience the performance of objects. Thus, the two-dimensional or three-dimensional technologies simulation technologies for simulating objects have low simulation efficiency.

Therefore, there is a need for simulating the operation for objects that lowers costs and raises simulation efficiency.

### BRIEF DESCRIPTION OF THE DRAWINGS

Various embodiments of the invention are disclosed in the following detailed description and the accompanying drawings.

FIG. 1A is a flowchart of a method for operating simulation of objects according to various embodiments of the present application.

FIG. 1B is a flowchart of a method for operating simulation of objects according to various embodiments of the present application.

FIG. 2 is a flowchart of a method for operating simulation of objects according to various embodiments of the present application.

FIG. 3 is a structural block diagram of a device for an operating simulation device of objects according to various embodiments of the present application.

FIG. 4 is a structural block diagram of a device for an operating simulation device of objects according to various embodiments of the present application.

FIG. 5 is a structural block diagram of a system of operating a simulation system of objects according to various embodiments of the present application.

FIG. 6 is a structural block diagram of a system for operating a simulation system of objects according to various embodiments of the present application.

FIG. 7 is a functional diagram of a computer system for operating a simulation system of objects according to various embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various embodiments of the present disclosure include a method, an apparatus, and a system for operating simulation of objects. As used herein, operating simulation of objects refers to having one user of a networked computer system perform certain operations on a physical object on behalf of another user and provide feedback. According to various embodiments of the present disclosure, the objects correspond to products. According to various embodiments of the present disclosure, simulation of objects can include simulating the objects in a web-based environment.

A terminal generally refers to a device used (e.g., by a user) within a network system and used to communicate with one or more servers. According to various embodiments of the present disclosure, a terminal may include communication functionality. For example, a terminal may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), or the like.

According to some embodiments of the present disclosure, a terminal includes a smart home appliance with communication functionality. A smart home appliance can be, for example, a television, a Digital Video Disk (DVD) player, an audio device, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, or the like.

According to various embodiments of the present disclosure, a terminal can be any combination of the foregoing devices. In addition, it will be apparent to one having ordinary skill in the art that a terminal according to various embodiments of the present disclosure is not limited to the foregoing devices.

Existing online operating simulation of objects is inefficient and ineffective. For example, some deficiencies associated with the operating simulation of objects according to some related art include inaccuracy and inconvenience. An example of simulation of an object includes sampling clothing items in the event the object corresponds to one or more clothing items. The sampling of the clothing items can include trying on clothes (e.g., simulating how a clothing item may fit on a user). Some existing methods for trying on a clothing item online (e.g., simulating the objects online) include (i) generating a simulation of how the clothing item fits on a virtual mannequin that is generated according to two-dimensional or three-dimensional technology; and (ii) generating a virtual mannequin using two-dimensional or three-dimensional technology based on one or more images of the user or user specifications (e.g., characteristics of the user such as size, shape, the like, or any combination thereof) such that the mannequin appears to exhibit the look and feel of the user (e.g., the characteristics of the user).

In greater detail, the first method for sampling the object (e.g., a clothing item) according to some related art uses two-dimensional or three-dimensional technology. A virtual mannequin is generated and selected (e.g., by a user) online. The user selects a simulated clothing item to be displayed on the mannequin (e.g., so as to appear as though the mannequin is wearing the selected clothing item). The final aggregate result (e.g., the mannequin being displayed as wearing the selected, simulated clothing item) is returned to the user (e.g., displayed to the user via a terminal).

The second method for sampling the object according to some related art uses a virtual mannequin that is generated according to user specifications. For example, the user uploads a photograph (e.g., an image file) that includes a representation of the user's face and body shape information. The body shape information can include an indication of a size of clothing that generally fits the user (e.g., an indication of size Small (S) clothes, size Medium (M) clothes, size Large (L) clothes, size Extra-Large (XL) clothes, size Extra-Extra Large (XXL) clothes, or the like). The industry website uses two-dimensional or three-dimensional technology and the user's face photograph and body shape information to generate a mannequin that has a face and body shape similar to the user's. Thereafter, the user selects a simulated clothing item (e.g., an object) to be represented on the virtual mannequin. The user can view the aggregate results (e.g., the simulated clothing item on the virtual mannequin).

The above techniques (e.g., using a ready-made virtual mannequin or a virtual mannequin generated according to a photograph that includes a representation of the user's face and body shape information) have deficiencies associated therewith. For example, accurately simulating a user's true appearance is difficult. In addition, various restrictions are forced on the objects. For example, clothes are required to undergo special processing before the virtual online clothes can be simulated (e.g., represented) on a mannequin. In addition, portraying quality, texture, and other properties of the objects are difficult. For example, a user can have difficulty acquiring quality, texture, and other properties of clothing from online simulation (e.g., online fitting).

In some embodiments, an initiator of the operating simulation may issue (e.g., generate and send) an operating simulation request to a platform. In some embodiments, the platform identifies a user who matches the requirements of the operating simulation request and pushes an operating simulation invitation to the matched user. The invited user can receive the operating simulation request and perform the operating simulation on the object offline. For example, in some embodiments, a user can view or otherwise perform a simulation of the object offline (e.g., when the user is not connected to a network such as the Internet). In some embodiments, the user operatively provides a simulation result of the operating simulation as feedback to the initiator in relation to the operating simulation.

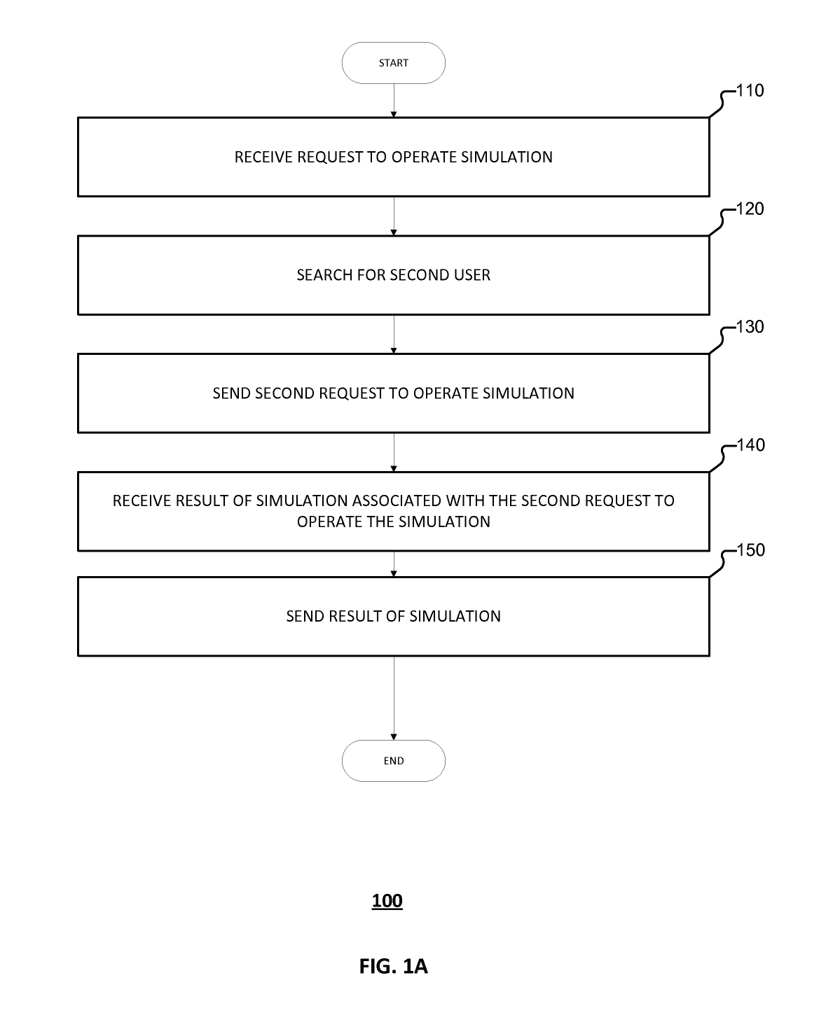

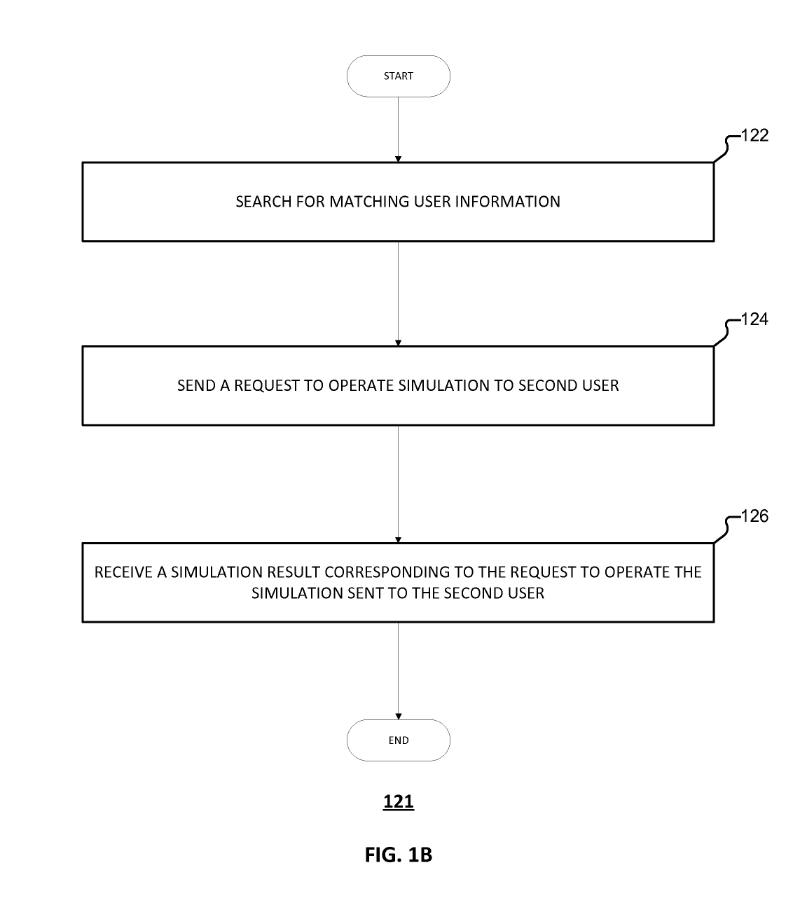

FIG. 1A is a flowchart of a method for operating simulation of objects according to various embodiments of the present application.

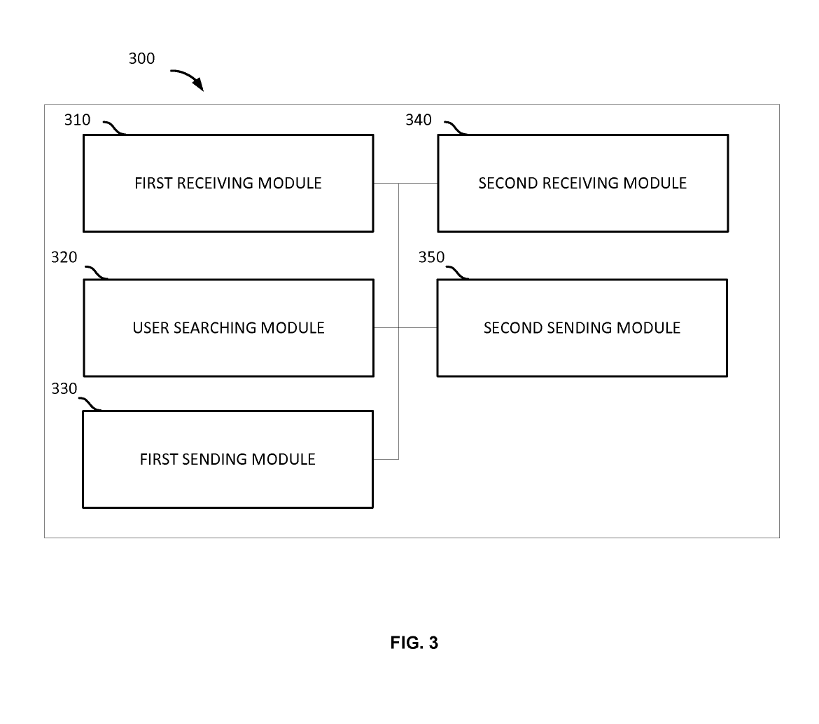

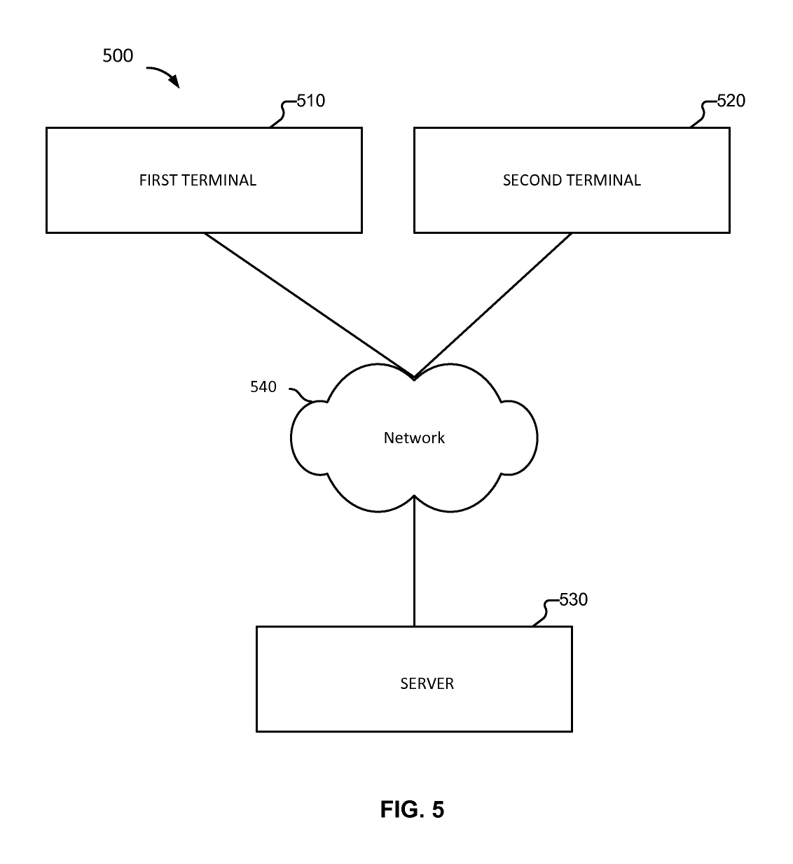

Referring to FIG. 1A, a method 100 for operating simulation of objects is provided. In some embodiments, the method 100 is implemented by device 300 of FIG. 3. In some embodiments, the method 100 is implemented by system 500 of FIG. 5.

At 110, a request to operate a simulation is received. In some embodiments, a server receives the request to operate the simulation (e.g., the first request to operate the simulation). The request to operate the simulation can be received from a user. In some embodiments, the request to operate a simulation corresponds to a request to run a simulation of an object. The user can submit (e.g., send) the request to operate the simulation via a browser on a terminal, an application installed on a terminal, or any combination thereof. For example, the user can submit the request to operate the simulation on a website (e.g., of a vendor or the like). As an example, a first user in a first geographic area (e.g., China) browsing an online retailer in a second geographic area (e.g., United States) can view a particular item (e.g., a handbag). The first user can submit a request to the system, including a request for the second user that simulates the item (e.g., tries out, or otherwise samples, the item). The first user can submit the request to the system via a button on a web browser, an application installed on a mobile device, or the like.

In some embodiments, different industries may have different objects associated therewith. For example, a particular industry can have an object that is unique to the particular industry. Each object can have different (e.g., unique) operating simulations associated therewith. For example, in the fashion industry, objects can include apparel, shoes, hats, socks, gloves, scarves, ties, handbags, parasols, hair accessories, and the like. The operating simulations for objects associated with the fashion industry can include trying on an object (e.g., a physical article of clothes, a physical watch, or the like). The operating simulations for the objects associated with the fashion industry can include trying on the objects to provide a user with a sense as to how the objects may fit, appear, or the like in relation to the user.

In some embodiments, a first user can log in to a network (e.g., a server, a service hosted by a server, or the like) at a first terminal (e.g., client). In the event that the first user is logged in to the network, the first user can submit, to a server, a first request to operate a simulation associated with an object. In some embodiments, the first request to operate the simulation includes information associated with the requested simulation (e.g., simulation requirement information). The information associated with the requested simulation can include demands of the first user with respect to the object. For example, the information associated with the requested simulation (e.g., user information) can include needs of the first user with respect to the object. As another example, the information associated with the requested simulation can include user preferences with respect to the object. As another example, the information associated with the requested simulation can include user characteristics with respect to one or more characteristics of the object. The information associated with the requested simulation can correspond to simulation requirements.

In some embodiments, the information associated with the requested simulation includes operating simulation user gender information, object parameter information regarding the object corresponding to the request to operate the simulation, simulation user quantity information, simulation location information, simulation authorized parameter information, any other appropriate parameters, or any combination thereof.

In some embodiments, the operating simulation user gender information limits the gender (e.g., male or female) of the second user that is performing the object operating simulation.

In some embodiments, the object parameter information limits the attributes of the object. In some embodiments, the object parameter information includes product type information, brand information, product number information, category information, size information, any other appropriate product information, or any combination thereof.

In some embodiments, the product type information limits the product type of the object (e.g., clothes, shoes, hats, backpacks, jewelry, watches, or the like). As an example, the product type information can define one or more product types for which the simulation can be operated.

In some embodiments, the brand information limits the brand of the object. As an example, the brand information can define one or more brands for which the simulation can be operated.

In some embodiments, the product number information limits the product number of the object. As an example, the product number information can define the product number for which the simulation can be operated. The product number can correspond to an object code. The object code can correspond to a unique code or product identifier that an object manufacturer uses to mark various objects (e.g., objects of different styles). In some embodiments, each style of merchandise has a corresponding unique product number.

In some embodiments, category information limits the category of the object. As an example, the category information can define the category of the object for which the simulation can be operated. For example, clothes are classified according to apparel material and production process. The clothes can include traditional Chinese apparel, Western apparel, embroidered apparel, woolen apparel, silk apparel, cotton apparel, leather and fur apparel, knit apparel, down apparel, any other appropriate category, or any combination thereof.

In some embodiments, the size information limits the size of objects (e.g., size S, size M, size L, size XL, size XXL, or the like). As an example, the size information can define a size of the objects for which the simulation can be operated.

In some embodiments, the simulation user quantity information limits the number of second users that perform object operating simulations. As an example, the simulation user quantity information can define a threshold number of users that can operate a simulation. The user quantity information can define a threshold number of users that can operate the simulation in relation to a specific object or a specific set of objects.

In some embodiments, simulation location information limits the location (e.g., a city, a township, a street, a state, a country, a geographical coordinate, or the like) at which an object simulation operation is performed. The location can be a range or set of locations (e.g., a range of geographic coordinates). As an example, the location information can define a location from which a user can request operation of a simulation of an object. The location information can define a permitted location for which simulation of an object can be operated.

In some embodiments, simulation authorized parameter information limits the authorized parameters needed to perform object simulation operations. Simulation authorized parameter information can include real money and/or virtual money. The simulation authorized parameter information can define prerequisites for operating the simulation. For example, the simulation authorized parameter information can define consideration that a user submitting a request for to operate a simulation must provide in order for the simulation to be operated for the user.

Information associated with the requested simulation can include other forms or types of information (e.g., that can define one or more parameters for operating the simulation). In some embodiments, other information associated with the requested simulation is configured according to actual conditions specific to implementation of that embodiment. The present application imposes no restrictions in this regard. In addition, persons skilled in the art may, as necessary, use other information associated with the requested simulation in addition to the information associated with the requested simulation described above. The present application imposes no restrictions in this regard.

At 120, a second user is searched. In some embodiments, a server searches for a second user. In some embodiments, a second user matching the information associated with the requested simulation is looked up in a database storing user data. In some embodiments, in response to receiving a request to operate a simulation from a first user, the server searches for a second user matching the information associated with the requested simulation (e.g., that is included with the request to operate the requested simulation). For example, the server can search for a second user having characteristics that match the information associated with the requested simulation. A second user that matches the information associated with the requested simulation can have a similarity among one or more characteristics (e.g., size, gender, location, preference, the like, or any combination thereof) with the information associated with the requested simulation that exceeds a predetermined similarity threshold (e.g., a threshold number of matching characteristics). The similarity threshold can be configurable by a user (e.g., the first user or the second user).

In some embodiments, the server searches for a match according to the information associated with the requested simulation (e.g., a second user suitable for carrying out the operating of the simulation in relation to the object). For example, the server can search for a match according to the information associated with the requested simulation corresponding to the first request to operate the simulation that was received from the first user (e.g., that was submitted or otherwise sent to the server by the first user).

In some embodiments, the second user has user information corresponding thereto. In some embodiments the second user registers the user information corresponding to the second user when registering an account (e.g., with the server). In some embodiments, the user information corresponding to the second user is configurable by the second user after the account associated with the second user is registered. For example, the second user can edit the user information corresponding to the second user.

In some embodiments, the user information corresponding to a particular user (e.g., the user information corresponding to the second user) includes gender information, body shape information, activity location information, the like, or any combination thereof. For example, the user information corresponding to a particular user can include characteristics associated with that particular user.

The gender information can record the gender of the particular user. For example, the gender information can be used to identify the gender of the second user.

The body shape information can record the body shape of the particular user. For example, the body shape information can be used to identify the body shape or other characteristics associated with fitting of the second user. The body shape information can include information relating to the particular user's figure. The body shape information can include information relating to a size or shape of the particular user. In some embodiments, the body shape information includes height information, weight information, chest/waist/hips information, shoulder width information, arm length information, leg length information, leg size information, head size information, the like, or any combination thereof.

The height information can record the height of the particular user. The weight information can record the bodyweight of the particular user. The chest/waist/hips information can record the three “circumferences” of the particular user (e.g., size information for chest, waist, and hips of the particular user). The shoulder width information can record the shoulder width of the particular user. The arm length information can record the arm length of the particular user. The leg length information can record the leg length of the particular user. The leg size information can record the leg size (e.g., circumference, or the like) of the particular user. The head size can include the head size of the particular user.

The activity location information can record the activity location of the particular user. The activity location of the particular user can correspond to the location at which the particular user is usually engaged in activities (e.g., a residence), a current location, or the like. For example, the activity location of the second user can correspond to a location from which the second user accesses a service (e.g., a service provided by the server such as a simulation service) most frequently.

In some embodiments, user information may be set up according to actual conditions. In some embodiments, the user information includes other types of information in addition to the types of user information described above.

FIG. 1B is a flowchart of a method for operating simulation of objects according to various embodiments of the present application. In some embodiments, the method 121 illustrated in FIG. 1B is used to implement 120 of FIG. 1A.

Referring to FIG. 1B, a method 121 for operating simulation of objects is provided. In some embodiments, the method 121 is implemented by device 300 of FIG. 3. In some embodiments, the method 121 is implemented by system 500 of FIG. 5.

At 122, matching user information is searched. In some embodiments, a server searches for user information matching information associated with the requested simulation. In connection with the method 100 illustrated in FIG. 1A, the server can search for user information that matches the information associated with the request to operate the simulation received at 110. In some embodiments, user information satisfying a similarity threshold is considered to match the information associated with the requested simulation. For example, a user information that has a threshold number of characteristics (e.g., operating simulation user gender information, object parameter information regarding the object corresponding to the request to operate the simulation, simulation user quantity information, simulation location information, simulation authorized parameter information, or the like) that are the same as corresponding characteristics of the information associated with the requested simulation is deemed to match the information associated with the requested simulation. As another example, user information that has a threshold degree of similarity across one or more characteristics of the information associated with the requested simulation is deemed to match the information associated with the requested simulation.

In some embodiments, a need or requirement of a first user (e.g., information associated with the requested simulation input by the first user) may be matched with the user information of a second user so as to find a suitable second user. As an example, a suitable second user can correspond to a second user having a highest degree of similarity to the information associated with the requested simulation input by the first user.

In some embodiments, the search for matching user information at 122 includes a search for gender information of a second user that matches (e.g., that is the same as) the gender information associated with the user associated with the request to operate the simulation (e.g., the first user). In some embodiments, the server searches for gender information of a second user matching user gender information associated with the request to operate the simulation (e.g., gender information included in the information associated with the requested simulation, gender information associated with the user from whom the request to operate the simulation is received). The server can retrieve the gender information associated with the request to operate simulation from the information associated with the requested simulation, or from a database storing pre-stored information or user configurations for the first user.

In some embodiments, the user gender information of an operating simulation is required to match the gender information of the second user. For example, in the event that the user gender information of the user associated with the request to operate the simulation is male, the gender of the second user is required to be male. Conversely, in the event that the user gender information of the user associated with the request to operate the simulation is female, the gender of the second user is required to be female. In some embodiments, the user gender information of the user associated with the request to operate the simulation is not restricted. For example, the gender information of the second user can be male or female.

In some embodiments, the search for matching user information at 122 includes a search for body shape information that matches (e.g., that is the same as) the body shape information associated with the user associated with the request to operate the simulation (e.g., the first user). In some embodiments, the server searches for a body shape range adapted to the information associated with the requested simulation (e.g., the object parameter information). The server can retrieve the body shape information associated with the request to operate the simulation from the information associated with the requested simulation, or from a database storing pre-stored information or user configurations for the first user. The server can configure a body shape range based on the body shape information associated with the request to operate the simulation. For example, the server can configure a body shape range to have a minimum size threshold and a maximum size threshold. The minimum size threshold can be configured to be within a predetermined number of sizes (e.g., two sizes) of a size corresponding to the body shape information associated with the request to operate the simulation. The maximum size threshold can be configured to be within a predetermined number of sizes of the size corresponding to the body shape information associated with the request to operate the simulation. In some embodiments, the minimum size threshold and the maximum size threshold can be defined according to a dimension (e.g., a waist of 32 inches, a leg length of 30 inches, or the like). In some embodiments, the body shape range can be predefined according to user configurations or user settings and stored in a database in connection with a user registration. For example, a user can configure a desired body shape range that is desirable for operating simulations.

In some embodiments, the search for matching user information at 122 includes a search for body shape information within a body shape range. In some embodiments, the server searches for body shape information based at least in part on the body shape range. For example, the server can search for body shape information within the body shape range.

In some embodiments, the information associated with the requested simulation (e.g., the object parameter information) defines (e.g., restricts) the range of the object body shape that is available for operating simulation. For example, size S clothing can require the following for the user: shoulder width 38 cm, chest 94 cm, waist 80 cm, hips 100 cm; and for the clothing: lower hem 112 cm, length 90 cm, cuff 24 cm, and sleeve length 59 cm. The adapted body shape range may be shoulder width 38±3 cm, chest 94±3 cm, waist 80±3 cm, hips 100±3 cm, and sleeve length 59±3 cm.

In some embodiments, after the body shape range is determined, a search is made for body shape information within the body shape range. For example, in response to the body shape range being determined, the server searches for body shape information within the body shape range. Body shape information that falls within the body shape range can be considered to be matching body shape information (e.g., body shape information that matches the body shape information associated with the user associated with the request to operate the simulation (e.g., the first user)).

In some embodiments, the categories of adapted body shape ranges restricted by object parameter information are not the same. For example, the categories of the adapted body shape range restricted by object parameter information and the body shape information that needs to be searched (e.g., the body shape information associated with the user associated with the request to operate the simulation) can be set. As an example, a clothing-limited body shape range can include shoulder width, chest, waist, hips, and arm length. Thus, shoulder width information, chest/waist/hips information, and arm length information can be searched within the clothing-limited body shape range. As a second example, a hat-limited body shape range can include head size. Thus, head size information may be searched within the hat-limited body shape range. As a third example, a pants-limited body shape range can include leg length, hips, and waist. Thus, leg length and chest/waist/hips information can be searched within the pants-limited body shape range.

In some embodiments, the search for matching user information at 122 includes a search for activity location information that matches (e.g., that is the same as) the activity location information associated with the user associated with the request to operate the simulation (e.g., the first user). In some embodiments, the server searches for activity location information matching location information associated with the request to operate the simulation (e.g., simulation location information included in the information associated with the requested simulation, location information associated with the user from whom the request to operate the simulation is received).

In some embodiments, simulation location information is matched with activity location information. As an example, in the event that the simulation location information is a city, matching activity location information can be associated with residing within that city. As a second example, in the event that the simulation location information is a shop (e.g., a vendor or a store), matching activity location information can be associated with a preset range of the shop. The preset range can be a range of locations within a threshold distance of a location (e.g., the shop). In this example, when engaged in activities (window-shopping) within the preset range, the user may find it convenient to perform the operating simulation for an object.

Returning to FIG. 1A, at 130, a second request to operate a simulation is communicated. In some embodiments, the server sends the second request to operate the simulation. The second request to operate the simulation can be sent to the second user. The second request to operate the simulation can be associated with simulating the object. For example, the object associated with the second request to operate the simulation can correspond to the object associated with the request to operate the simulation received from the user (e.g., the request to operate the simulation received at 110). In response to receiving the second request to operate the simulation, the second user can be prompted as to whether to accept the second request to operate the simulation (and to perform the requested simulation). In response to receiving an acceptance of the second request to operate the simulation, the second client or the server can operate the simulation.

In some embodiments, in the event that the server receives an operating simulation request from a first user, the first user's needs (e.g., exact needs) are analyzed and collated, and an automatic search is begun for second users that meet the first user's needs to assist with the operating simulation. For example, in the event that the server receives an operating simulation request from the first user, the information associated with the requested simulation (e.g., information which includes an indication of the first user's needs) is analyzed. Based at least in part on the analysis of the information associated with the requested simulation, a search for a second user that matches the information associated with the requested simulation is searched. The activity status of the second users that are found based on the search for a second user that matches the information associated with the requested simulation can be “currently shopping” or “going shopping” so as to facilitate second user performance of the object operating simulation and to increase the probability of the object operating simulation succeeding. For example, the search for a second user that matches the information associated with the requested simulation can include a filter for a second user having a particular activity status. In the event that the server finds a suitable second user, the server sends to the second user an operating simulation invitation (e.g., a second operating simulation request).

In some embodiments, a user (e.g., the second users) can manually configure a status. For example, the user can set the user's status to “currently shopping” or “going shopping.” As another example, the server can set the user's status to “inactive” according to whether the user is logged in, whether the user has interacted with the server within a threshold period of time, or the like. The threshold period of time can be configurable (e.g., by an administrator, by the user, or the like). As another example, the server can set the user's status to “active” according to whether the user is logged in, whether the user has interacted with the server within a threshold period of time, or the like. The threshold period of time can be configurable (e.g., by an administrator, by the user, or the like).

In some embodiments, a status of a user (e.g., the second users) according to a context of the second user. For example, the second user can have a mobile device that has an application installed thereon. The application installed on the mobile device can determine, or monitor, the second user's geographical location. The application can automatically configure the status of the second user based at least in part on the geographical location. In some embodiments, the application can report the geographical location of the second user, and the server can automatically configure the status of the second user based at least in part on the geographical location. For example, the status of the second user can be set to be “currently shopping” in the event that the geographical location of the second user corresponds to (e.g., matches within a threshold distance) a geographical location of a retailer such as a department store, or the like.

In some embodiments, a second user logs in, from a second client, to a network or a website (e.g., the website to which the request to operate the simulation is submitted). In the event that the second user is logged in to the network or the website, the server can send a second operating simulation request for the object to the second client. In some embodiments, the search for a second user that matches the information associated with the requested simulation can include a filter for a second user that is logged in to the network or the website (e.g., at the time that the search for the second user is performed). In some embodiments, simulation requirement information is communicated in connection with the second request to operate the simulation. For example, the second request to operate the simulation can include the simulation requirement information. The simulation requirement information can include the operating simulation needs of the first user with respect to the object.

At 140, a result of a simulation associated with the second request to operate the simulation is received. In some embodiments, the server receives the result of the simulation associated with the second request to operate the simulation. The server can receive the result of the simulation from the second user (e.g., the second client). For example, in the event that the second user has accepted the second request to operate the simulation, the server receives the simulation result submitted by the second user and obtained from subjecting the object to the operating simulation in accordance with the simulation requirement information.

In some embodiments, a second user logs into a network or a website at a second client. The second user can receive through a second client a second request to operate a simulation for an object sent by the server. Information associated with the requested simulation can be sent in connection with the second request to operate the simulation. For example, the second request to operate the simulation can include the information associated with the requested simulation. For example, the second request to operate the simulation can include simulation requirement information. In the event that the second client (e.g., the second user) receives the second request to operate the simulation and the information associated with the requested simulation, the second user can view the simulation requirement information. The second user can use the simulation requirement information as a basis for determining whether to accept the second request to operate the simulation. For example, the second user can, after viewing the simulation requirement information, choose to accept or reject the invitation (the second request to operate the simulation).

In the event that the second user accepts the second request to operate the simulation, the second user may access the location indicated by the information associated with the requested simulation (e.g., the simulation location information). For example, the second user may be redirected to the location indicated by the information associated with the requested simulation. The second user can use the object parameter information to find the object indicated by the first user. For example, in the event that the second user is at the location indicated by the information associated with the requested simulation, the second user can use the object parameter information. The second user can use the object parameter information (e.g., at the location indicated by the information associated with the requested simulation) to perform or operate the simulation. As an example, the second user can personally try on the actual clothes corresponding to the object parameter information.

In some embodiments, in the event that the number of second users accepting an invitation (e.g., the second request to operate the simulation) exceeds the quantity corresponding to the simulation user quantity information, the server can reject operating simulation by other users.

After the second user completes the operating simulation, the second user can provide the obtained simulation result as feedback. For example, in response to completing the operation of the simulation, the second user can send feedback to the server. The simulation result can include the effect of the operating simulation (e.g., the effect of the second user trying on the clothes or the on-site photographic effect of the clothes), the second user's evaluation of the object (e.g., the texture of the clothes or the actual selling price of the clothes), or the like. For example, the second user can provide the first user with a subjective opinion of the object related to the first request to operate the simulation.

In some embodiments, the simulation result includes simulation picture information, simulation text information, simulation audio information, simulation video information, the like, or any combination thereof.

For example, the second user may provide (e.g., as feedback) the simulation result in the form of an image, text, audio, video, the like, or any combination thereof. The second user can submit the simulation result to a webpage (e.g., as an upload). In some embodiments, the second user can communicate the simulation result to the first user. The second user can also display the simulation result in other forms.

At 150, the result of the simulation is communicated. For example, the result of the simulation associated with the second request to operate the simulation is communicated. In some embodiments, the server sends the result of the simulation to the first user. The server can send the result of the simulation to the first user in response to the server receiving the result of the simulation from the second user. The server can send the result of the simulation to an address of the first user in connection with a messaging system associated with the server (e.g., or a website or service associated with the server to which the first request to operate the simulation is sent).

In some embodiments, the first user logs in to a network or website at a first client. In the event that the first user logs into the network or the website, the first user can retrieve the result of the simulation. For example, in the event that the first user logs in to the network or the website, the server can send the simulation result to the first user.

After the first user views the result of the simulation, the first user can select the result of the simulation of one or more second users as outstanding simulation results. In some embodiments, the server can take (e.g., copy) the corresponding authorized parameter from the account of the first user and save the corresponding authorized parameter in the account of one or more second users. The authorized parameter can correspond to the second user's authorized information such as height, weight, or the like for future communication.

In some embodiments, a particular second user matching information associated with the request to operate the simulation (e.g., simulation requirement information) can be selected based on a rating associated with the particular second user. For example, the rating can be a peer rating that is provided as feedback (e.g., from a first user) based at least in part on the results of the simulation that are provided by the second user.

In some embodiments, a second user that provides a result of the simulation can receive a credit associated with the website. For example, registered users of a website can earn credits with the website by performing a simulation of an object and providing the results of the simulation to the website or a first user that submitted the request to operate the simulation. As another example, the second user can be compensated for performing a simulation of an object and providing the results of the simulation to the website or a first user that submitted the request to operate the simulation.

In some embodiments, after the request to operate the simulation for the object is received from the first user, a search is made for second users matching information associated with the request to operate the simulation (e.g., simulation requirement information). One or more of the second users that match the information associated with the request to operate the simulation are sent a second request to operate the simulation. After the second users receive the operating simulation request, the second users can perform the operating simulation on the object (e.g., in a real life environment on the actual physical object). The second users can obtain the result of the simulation and feed the result of the simulation back to the first user. In some embodiments, the information exchange (e.g., of the feedback associated with the results of the simulation) between the first user and the second users is in the form of a point-to-point or real person-to-real person exchange. A simulation result obtained by a real person will be more authentic, accurate, visually comprehensible, and detailed than one from an online mannequin operating simulation. The operating simulation results obtained by second users enable the first user to transcend temporal and spatial limitations and greatly increase the flexibility of operating simulations. In addition, operating simulation results obtained by second users do not require the use of a mannequin formed using two-dimensional or three-dimensional technology. The operating simulation results obtained by second users lower users' requirements for operating simulations, and greatly lower the cost of operating simulations. Furthermore, the online-offline interaction not only greatly enhances user experience, but also obviously promotes the flourishing of online and offline ecological chains.

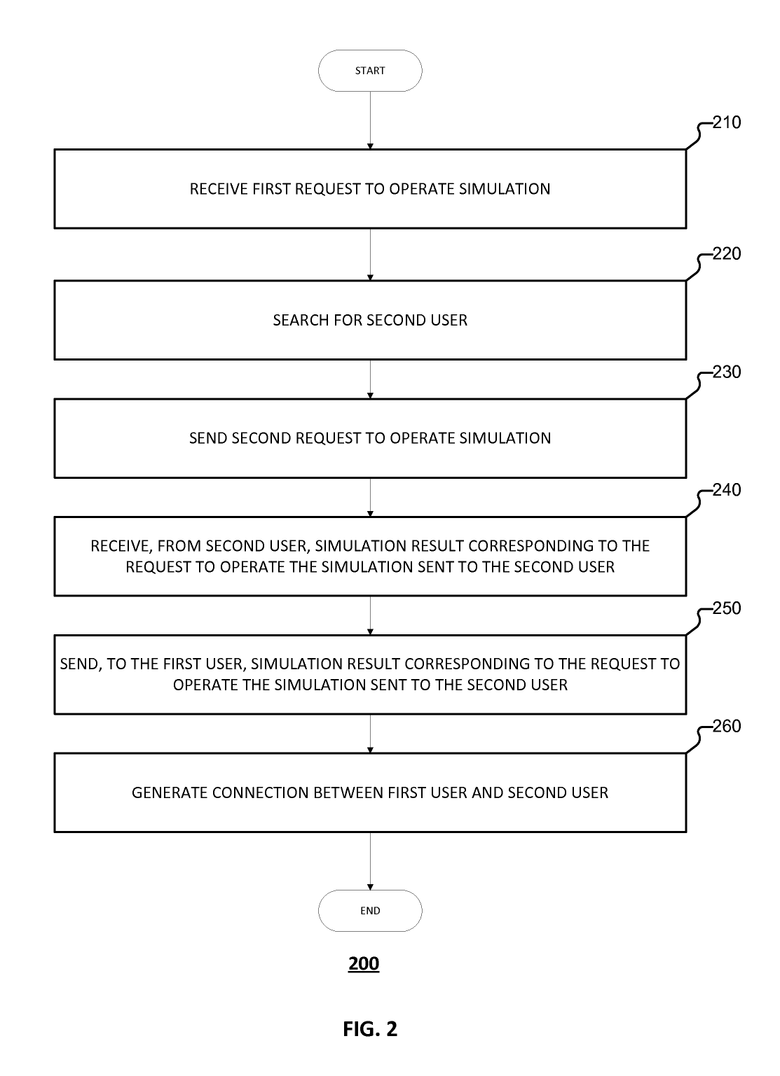

FIG. 2 is a flowchart of a method for operating simulation of objects according to various embodiments of the present application.

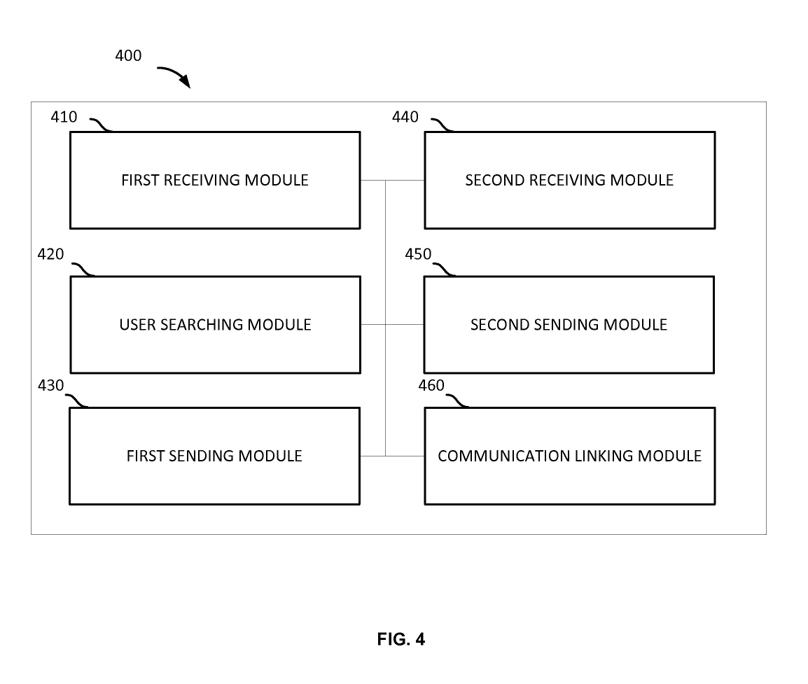

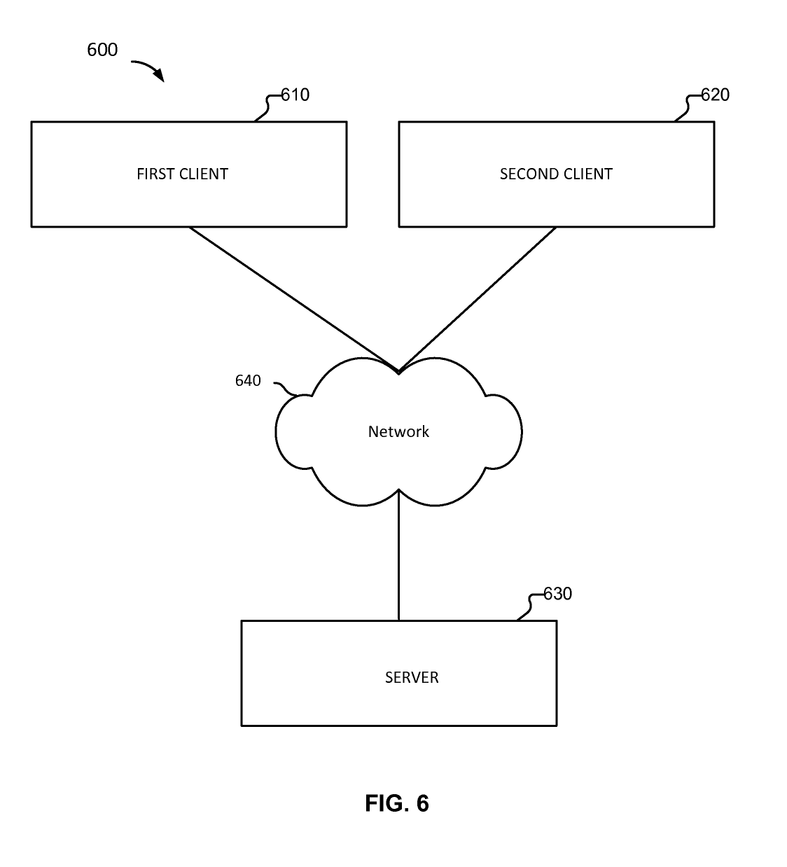

Referring to FIG. 2, a method 200 for operating simulation of objects is provided. In some embodiments, the method 200 is implemented by device 400 of FIG. 4. In some embodiments, the method 200 is implemented by system 600 of FIG. 6.

At 210, a request to operate a simulation is received. In some embodiments, a server receives the request to operate the simulation (e.g., the first request to operate the simulation). The request to operate the simulation can be received from a user. In some embodiments, the request to operate a simulation corresponds to a request to run a simulation of an object. The user can submit (e.g., send) the request to operate the simulation via a browser on a terminal, an application installed on a terminal, the like, or any combination thereof. For example, the user can submit the request to operate the simulation on a website (e.g., of a vendor or the like). In some embodiments, information associated with the requested simulation (e.g., simulation requirement information) can be received in connection with the first request to operate the simulation request. For example, the first request to operate the simulation can include simulation requirement information. As an example, a first user in a first geographic area (e.g., China) browsing an online retailer in a second geographic area (e.g., United States) can view a particular item (e.g., a handbag). The first user can submit a request to the system, including a request for the second user that simulates the item (e.g., tries out, or otherwise samples, the item). The first user can submit the request to the system via a button on a web browser, an application installed on a mobile device, or the like.

The information associated with the requested simulation can include demands of the first user with respect to the object. For example, the information associated with the requested simulation (e.g., user information) can include needs of the first user with respect to the object. As another example, the information associated with the requested simulation can include user preferences with respect to the object. As another example, the information associated with the requested simulation can include user characteristics with respect to one or more characteristics of the object. The information associated with the requested simulation can correspond to simulation requirements.

In some embodiments, the information associated with the requested simulation includes operating simulation user gender information, object parameter information regarding the object corresponding to the request to operate the simulation, simulation user quantity information, simulation location information, simulation authorized parameter information, the like, or any combination thereof.

At 220, similar to 120 of FIG. 1A, a second user is searched. In some embodiments, a server searches a user database to find a second user matching the information associated with the requested simulation. In some embodiments, in response to receiving a request to operate a simulation from a first user, the server searches for a second user matching the information associated with the requested simulation (e.g., that is included with the request to operate the requested simulation). For example, the server can search for a second user having characteristics that match the information associated with the requested simulation. A second user that matches the information associated with the requested simulation can have a similarity among one or more characteristics (e.g., size, preference, the like, or any combination thereof) with the information associated with the requested simulation that exceeds a predetermined similarity threshold. The similarity threshold can be configurable by a user (e.g., the first user or the second user).

At 230, a second request to operate a simulation is communicated. In some embodiments, the server sends the second request to operate the simulation. The second request to operate the simulation can be sent to the second user. The second request to operate the simulation can be associated with simulating the object. For example, the object associated with the second request to operate the simulation can correspond to the object associated with the request to operate the simulation received from the user (e.g., the request to operate the simulation received at 210). In some embodiments, information associated with the requested simulation can be communicated in connection with the second request to operate the simulation. For example, the second request to operate the simulation can include information associated with the requested simulation (e.g., simulation requirement information).

At 240, a result of a simulation associated with the second request to operate the simulation is received. In some embodiments, the server receives the result of the simulation associated with the second request to operate the simulation. The server can receive the result of the simulation from the second user (e.g., the second client). For example, in the event that the second user has accepted the second request to operate simulation, the server receives the simulation result submitted by the second user and obtained from subjecting the object to the operating simulation in accordance with the simulation requirement information.

At 250, the result of the simulation is communicated. For example, the result of the simulation associated with the second request to operate the simulation is communicated. In some embodiments, the server sends the result of the simulation to the first user. The server can send the result of the simulation to the first user in response to the server receiving the result of the simulation from the second user. The server can send the result of the simulation to an address of the first user in connection with a messaging system associated with the server (e.g., or a website or service associated with the server to which the first request to operate the simulation is sent).

At 260, a connection between the first user and the second user is generated. In some embodiments, the server generates the connection between the first user and the second user. For example, in the event that a communication request submitted by the first user is received, a communication link (e.g., an instant messaging session, a video chat session, etc.) between the first user and the second user is established. The communication link can be established using libraries and API calls associated with the specific type of session, such as open socket calls. The server can receive the communication request from the first user. For example, the first user can submit the communication request via a website (e.g., a website associated with the service to which the first user can submit the first request to operate the simulation).

As an example, the first user can log in at a first client, and a second user can log in at a second client. The first client and the second client can be a device such as a mobile device (e.g., tablet computers, personal digital assistants, mobile phones, or the like). The first client and the second client can have various operating systems. For example, the first client and the second client can have operating system versions corresponding to IOS, Android, Windows Phone, or the like.

In some embodiments, the first user can submit the communication request via the first client. For example, the first user can submit a communication request for communicating with a specific second user. The first user can submit a communication request for communicating with a second user that provided a result of the simulation.

In the event that the server receives a communication request submitted by the first user, the server can establish a communication link between the first user and the second user. The specific form of communication may be instant messaging. The form of communication for the communication link between the first user and the second user can be another form of communication such as email (electronic mail), a video chat, a Short Message Service (SMS) message, or the like.

In some embodiments, in the event that a communication link is established between the first user and the second user, the first user can carry out real-time communication with the second user. For example, the first user and the second user can communicate with each other in real-time online.

The communication link established between the first user and the second user enables the first user and the second user to directly communicate in real time. The real-time communication between the first user and the second user in turn helps the first user acquire simulation results that are more authentic, accurate, visually comprehensible, and detailed. Accordingly, the real-time communication between the first user and the second user greatly increases the flexibility of acquiring simulation results.

Various embodiments of the present application are further described through several application scenario examples:

### Example 1

### The Object Corresponds to Clothes, and the Operating Simulation Corresponds to Trying on Clothes

According to the first example, the first user is preparing to purchase clothes on a shopping website. For example, the first user can be a buyer who is purchasing clothes. A buyer who is purchasing clothes (e.g., the first user) often wishes to learn more about the texture, fit, and the like of the clothes that are available online at the shopping website. However, the brick-and-mortar shop corresponding to the vendor for the clothes that the first user is preparing to purchase may not be within the first user's area (e.g., city, township, or the like). Alternatively, the first user may not have time to physically go to the brick-and-mortar shop to try on the clothes. In some embodiments, the first user can ask a second user who is in the area of the brick-and-mortar shop and whose figure approximates that of the first user to go to the brick-and-mortar shop and try on the clothes and thereby obtain such information as texture, wearing effect, and so on. In other words, the first user can ask the second user for feedback or the second user's opinion of the clothes that are of interest to the first user.

Referring to FIG. 1A, at 120, the first user can submit a request to operate the simulation of the object. For example, the initiator (e.g., the first user) of the clothes-fitting (trying on clothes) request describes the conditions for trying on the clothes. The conditions for trying on the clothes can correspond to the simulation requirement information associated with the first user in relation to the particular object subject to the request to operate the simulation. The conditions for trying on the clothes can include information indicating a product type, a gender, a brand, a product number, a category, a size, a number of persons to try on the clothes, a location, and a compensation for trying on the clothes. For example, the conditions for trying on the clothes can include:

Product type: Clothes

Gender: Female

Brand: ONLY

Product number: 113255004

Category: Three-quarters sleeve blazer

Size: M

Number of persons to try on clothes: 1 person.

Location (Clothes fitting location): Washington, D.C.

Tip/Compensation: $5

Referring to FIG. 1A, at 120, the server searches for a second user. For example, the server queries a database for a second user that matches the parameters (e.g., the information associated with the request to operate the simulation such as the simulation requirement information). As an example, the server analyzes each entry in a database seeking a match according to the conditions described by the clothes-fitting request initiator. The process for searching for the second user includes querying the database (e.g., filtering the database) according to a gender specified in the information associated with the request to operate the simulation (e.g., the conditions for trying on the clothes).

The process for searching for the second user includes querying a database (e.g., filtering the database) according to a status of the second users. For example, after matching second users according to gender, the server can query the database (e.g., filter the database) for, or otherwise select, second users who are window-shopping and wish to accept the clothes-fitting requests. In some embodiments, a user registered with the website can update the user's status via a device such as a mobile phone. For example, the user's status can include location obtained by the mobile phone's location service, a willingness to accept a request to operate simulation, and a desired compensation as specified by the user or the like.

The process for searching for the second user includes matching second users with first users according to one or more body type characteristics (e.g., body shape information). The server can query a database (e.g., filter the database) according to one or more body type characteristics. For example, a second user is matched with the first user according to the body type characteristics of the clothes-fitting initiator and the body type characteristics information filled in by invitees (second users). The one or more body type characteristics of a particular user can be information that is stored in a database in connection with a profile of the particular user. The filtering of the database for the second users according to one or more body type characteristics can be performed after the one or more second users are matched according to the body type characteristics.

The process for searching for the second user includes querying a database (e.g., filtering the database) according to a location. For example, the users of the clothes-fitting platform update their current city locations and matching users located in Washington, D.C. are found. The filtering of the database for second users according to a location of the second users can be performed after one or more second users are matched according to the one or more body type characteristics.

If all of the above conditions are met, invitees (e.g., second users) are confirmed as having met the clothes-fitting conditions (e.g., simulation requirement information) described by the initiator (e.g., the first user).

Returning to the first example, referring to 124 of FIG. 1B, the server sends a clothes-fitting invitation to invitees who meet the conditions. For example, the server sends the second request to operate the simulation to the matching second users.

Referring to FIG. 1B, at 124, one or more invitees accept the clothes-fitting invitation. In response to receiving the clothes-fitting invitation, one or more invitees can submit a response indicating acceptance of the clothes-fitting invitation. The response indicating acceptance of the clothes-fitting invitation can be submitted to the website.

Referring to FIG. 1B, at 124, at the clothes-fitting location, the invitees look for the clothes specified by the initiator and try on the clothes. For example, the second users that accepted the second request to operate the simulation (e.g., the clothes-fitting invitation) can proceed to the location associated with the requested simulation (e.g., the physical location of the store or vendor associated with the object) and perform the simulation (e.g., try on the clothes).

Referring to FIG. 1B, at 126, the invitees provide the clothes-fitting result as feedback to the initiator. For example, invitee A sends back a photograph of herself wearing the clothes and provides a text summary: “Overall, this style feels relatively fashionable, but the clothes have a rather coarse texture, which when worn is not so comfortable on the skin.” Invitee B sends back a video of herself wearing the clothes and provides a text summary: “The proprietor is not bad, and the color looks pretty good. However, the clothes seemed a little too large when I put them on. The fabric is cotton and it is crudely made. There are a lot of thread ends hanging out. The clothes are low-quality and somewhat wrinkled, so give the clothes an ironing. The clothes are not so bad for plain cotton clothes.” As an example, the second users submit a result of the simulation. The result of the simulation can be submitted to the website or directly to the first user.

Thereafter, the initiator evaluates the clothes-fitting results and selects the best clothes-fitting results and issues a tip (e.g., compensation) to the invitee who obtained or submitted the best clothes-fitting result. For example, the initiator may select the clothes-fitting result of invitee B as the best clothes-fitting result. Given the clothes-fitting results of invitee A and invitee B, the initiator can see that the clothes were poorly made. Therefore, the initiator may give up on purchasing these clothes. As an example, the first user can review the results of the simulation submitted by one or more second users and compensate one or more second users that submitted a result of the simulation. The first user can decide whether to compensate a second user based on a quality of the result of the simulation submitted by the second user (e.g., whether the result of the simulation was informative). In some embodiments, the first user can submit a peer-review or rating of one or more of the second users that submitted a result of the simulation. In some embodiments, the second user can submit a peer-review or rating of the first user that requested the simulation.

### Example 2

### The Object Corresponds to a Watch, and the Operating Simulation Corresponds to Trying on a Watch

According to the second example, the first user is preparing to purchase a watch during an upcoming sight-seeing or business trip. First, the first user views the relevant models of watches on a website. For example, the first user can be a buyer who is purchasing a watch. Because the itinerary of the first user's sight-seeing or business trip may be constrained, a first user often wishes to learn more about watches. For example, the first user may wish to know the prices of watches in the brick-and-mortar store, the textures of the watches, how the watches look and feel when worn, etc. The first user may wish to learn about the watches so that the first user can then conduct a further screening and enable smooth and fast purchasing during the sight-seeing or business trip. In some embodiments, a first user requests a second user who is in the area of the first user's sight-seeing or business trip destination and who has a figure (e.g., one or more body-type characteristics) that approximates the figure of the first user to go try on a watch specified by the first user and thereby obtain information about the watch that is requested by the first user. For example, the first user can request that the second user obtain information about the watch such as the price of the watch in the brick-and-mortar store, the texture of the watch, and how the watch looks and feels when worn. In other words, the first user can ask the second user for feedback or the second user's opinion of the watch that is of interest to the first user.

Referring to FIG. 2, at 210, the first user can submit a request to operate the simulation of the object. For example, the initiator (e.g., the first user) of the watch-fitting (trying on watch) request describes the conditions for trying on a watch. The conditions for trying on the watch can correspond to the simulation requirement information associated with the first user in relation to the particular object subject to the request to operate the simulation. The conditions for trying on the watch can include information indicating a product type, a gender, a brand, a product number, a category, a size, a number of persons to try on the watch, a location, and a compensation for trying on the watch. For example, the conditions for trying on the watch can include:

Product type: Watches

Gender: Male

Brand name: Longines Master Collection

Product number: L2.628.4.78.6

Category: Automatic, mechanical watches

Number of persons to try on the watch: 1 person.

Location (Watch-fitting location): New York City

Tip/Compensation: $20

Referring to FIG. 2, at 220, the server searches for a second user. For example, the server queries a database for a second user that matches the parameters (e.g., the information associated with the request to operate the simulation such as the simulation requirement information). As an example, the server analyzes each entry in a database seeking a match according to the conditions described by the watch-fitting request initiator. The server can query the database (e.g., filter the database) according to parameters defined by the first user (e.g., information associated with the first request to operate the simulation). The server selects a suitable user (e.g., a second user) and sends a watch-fitting request for the watch (e.g., a second request to operate the simulation). The watch-fitting request can correspond to a watch-fitting invitation.

Referring to FIG. 2, in response to sending the second request to operate simulation at 230, one or more invitees (e.g., second users) accept the watch-fitting invitation. In response to receiving the watch-fitting invitation, one or more invitees can submit a response indicating acceptance of the watch-fitting invitation. The response indicating acceptance of the watch-fitting invitation can be submitted to the website.

Next, at the watch-fitting location, the invitee looks for the watch specified by the initiator and tries on the watch. For example, the second users that accepted the second request to operate the simulation (e.g., the watch-fitting invitation) can proceed to the location associated with the requested simulation (e.g., the physical location of the store or vendor associated with the object) and perform the simulation (e.g., try on the watch).

Referring to FIG. 2, at 240 and 250, the invitee provides the watch-fitting result as feedback to the initiator. For example, an invitee sends back one full-body photo of the invitee wearing the watch and an image specially focused on the watch while the invitee is wearing the watch. Moreover, the invitee sends back a brief description: “The watch has a very pretty blue surface. The watch is restrained, staid, and elegant. The watch is quite heavy and the watch is very nicely packaged. Both the watch face and band have a plastic protective sheath. The price is appropriate. The 39 mm surface is not very large; the watch fits my wrist rather well.” As an example, the second users submit a result of the simulation. The result of the simulation can be submitted to the website or directly to the first user.

Referring to FIG. 2, at 260, the initiator and the invitee engage in an online exchange so as to acquire more detailed watch-fitting results. For example, the first user can request or initiate a communication with the second user in order to communicate details about the result of the simulation. The first user can request additional description of the result of the simulation. In some embodiments, the second user can request or initiate a communication with the first user. For example, the second user can request or initiate the communication with the first user to request further information regarding the wants, preferences, or needs of the first user. As an example, the second user can request or initiate communication with the first user while the second user is performing the requested simulation (e.g., when the second user is located at the physical location of the vendor of the object).

Thereafter, the initiator evaluates the watch-fitting results and selects the best watch-fitting result and issues a tip (e.g., compensation) to the invitee who obtained the best watch-fitting result. Given the watching-fitting result from the invitee, the initiator can see that the watch's overall quality and effects are relatively good. Therefore, the initiator can confirm the initiator's intention of purchasing the watch. As an example, the first user can review the results of the simulation submitted by one or more second users and compensate one or more second users that submitted a result of the simulation. The first user can decide whether to compensate a second user based on a quality of the result of the simulation submitted by the second user (e.g., whether the result of the simulation was informative). In some embodiments, the first user can submit a peer-review or rating of one or more of the second users that submitted a result of the simulation. In some embodiments, the second user can submit a peer-review or rating of the first user that requested the simulation.

FIG. 3 is a structural block diagram of a device for an operating simulation device of objects according to various embodiments of the present application.

Referring to FIG. 3, a device 300 for operating a simulation of an object is provided. In some embodiments, the device 300 implements a method, such as, method 100 illustrated in FIG. 1A, method 121 illustrated in FIG. 1B, or the like. In some embodiments, the device 300 is implemented in system 500 illustrated in FIG. 5. For example, the device 300 can be implemented as the server 530 in the system 500 illustrated in FIG. 5.

As illustrated in FIG. 3, the device 300 can include a first receiving module 310, a user searching module 320, a first sending module 330, a second receiving module 340, and a second sending module 350.

In some embodiments, the first receiving module 310 is configured to receive an object first operating simulation request submitted by a first user. For example, the first receiving module 310 receives the first request to operate the simulation. The first receiving module 310 can receive information associated with the first request to operate the simulation. The first request to operate the simulation can include the information associated with the first request to operate the simulation (e.g., simulation requirement information). The first request to operate the simulation can relate to a business subject. For example, the first request to operate the simulation can identify an object subject to the request to operate the simulation.

In some embodiments, the user searching module 320 is configured to search for a second user matching the information associated with the first request to operate the simulation (e.g., simulation requirement information). The user searching module 320 can query a database for one or more matching second users. In some embodiments, in response to the first receiving module 310 receiving a request to operate a simulation from a first user, the user searching module 320 searches for a second user matching the information associated with the requested simulation (e.g., that is included with the request to operate the requested simulation). For example, the user searching module 320 can search for a second user having characteristics that match the information associated with the requested simulation. A second user that matches the information associated with the requested simulation can have a similarity among one or more characteristics (e.g., size, preference, the like, or any combination thereof) with the information associated with the requested simulation that exceeds a predetermined similarity threshold. The similarity threshold can be configurable by a user (e.g., the first user or the second user).

In some embodiments, the first sending module 330 is configured to send to the second user a second request to operate the simulation. The second request to operate the simulation can relate to the object (e.g., the object associated with the first request to operate the simulation). The second request to operate the simulation can include the information associated with the first request to operate the simulation (e.g., simulation requirement information).

In some embodiments, the second receiving module 340 is configured to receive a result of the simulation. For example, the second receiving module 340 is configured to receive a result of the simulation submitted by one or more second users. In the event that a second user has accepted the second request to operate the simulation, the second receiving module 340 receives the simulation result submitted by the second user and obtained from subjecting the object to the operating simulation in accordance with the simulation requirement information.

In some embodiment, the second sending module 350 is configured to send the result of the simulation to the first user. The second sending module 350 can send the result of the simulation to the first user in response to the second receiving module 340 receiving the result of the simulation.

In some embodiments, the information associated with the request to operate the simulation (e.g., simulation requirement information) can include operating simulation user gender information, object parameter information regarding the object corresponding to the request to operate the simulation, simulation user quantity information, simulation location information, simulation authorized parameter information, the like, or any combination thereof.

In some embodiments, the business parameter information regarding the object corresponding to the request to operate the simulation can include product type information, brand information, product number information, category information, size information, the like, or any combination thereof.

In some embodiments, the second user can have user information. The user information can be associated with a registration of the second user with the website. The user information can include gender information, body shape information, activity location information, the like, or any combination thereof.

In some embodiments, the second user body shape information can include height information, weight information, chest/waist/hips information, shoulder width information, arm length information, leg length information, leg size information, head size information, the like, or any combination thereof.

In some embodiments, the user searching module 320 can include a user information searching sub-module, an assessing sub-module, or the like.

In some embodiments, the user information searching sub-module can be configured to search for user information matching the information associated with the request to operate the simulation (e.g., the simulation requirement information).

In some embodiments, the assessing sub-module is configured to assess whether the second user corresponds to a second user matching the information associated with the request to operate the simulation (e.g., the simulation requirement information). For example, the assessing sub-module can assess whether the second user corresponds to a second user matching the simulation requirement information upon finding the user information of a second user.

In some embodiments, the user information searching sub-module can include a first searching sub-module, a second searching sub-module, a third searching sub-module, a fourth searching sub-module, the like, or any combination thereof.

In some embodiments, the first searching sub-module is configured to search for gender information of a second user matching user gender information for the simulation operation. For example, the first searching sub-module searches for gender information of a second user that matches gender information included in the information associated with the first request to operate the simulation.

In some embodiments, the second searching sub-module is configured to search for a body shape range adapted to the object parameter information. For example, the second searching sub-module searches for a body shape range matching the information associated with the first request to operate the simulation.

In some embodiments, the third searching sub-module is configured to search for body shape information within the body shape range.

In some embodiments, the fourth searching sub-module is configured to search for activity location information matching the simulation location information. For example, the fourth searching sub-module searches for activity location information matching the information associated with the first request to operate the simulation (e.g., location information associated with the requested simulation).

In some embodiments, the result of simulation can include simulation picture information, simulation text information, simulation audio information, simulation video information, the like, or any combination thereof.

FIG. 4 is a structural block diagram of a device for an operating simulation device of objects according to various embodiments of the present application.

Referring to FIG. 4, a device 400 for operating a simulation of an object is provided. In some embodiments, the device 400 implements a method, such as method 200 illustrated in FIG. 2. In some embodiments, the device 400 is implemented in system 600 illustrated in FIG. 6. For example, the device 400 can be implemented as the server 630 in the system 600 illustrated in FIG. 6.

As illustrated in FIG. 4, the device 400 can include a first receiving module 410, a user searching module 420, a first sending module 430, a second receiving module 440, a second sending module 450, and a communication linking module 460.

In some embodiments, the first receiving module 410 is configured to receive an object first operating simulation request submitted by a first user. For example, the first receiving module 410 receives the first request to operate the simulation. The first receiving module 410 can receive information associated with the first request to operate the simulation. The first request to operate the simulation can include the information associated with the first request to operate the simulation (e.g., simulation requirement information). The first request to operate the simulation can relate to a business subject. For example, the first request to operate the simulation can identify an object subject to the request to operate the simulation.

In some embodiments, the user searching module 420 is configured to search for a second user matching the information associated with the first request to operate the simulation (e.g., simulation requirement information). The user searching module 420 can query a database for one or more matching second users. In some embodiments, in response to the first receiving module 410 receiving a request to operate a simulation from a first user, the user searching module 420 searches for a second user matching the information associated with the requested simulation (e.g., that is included with the request to operate the requested simulation). For example, the user searching module 420 can search for a second user having characteristics that match the information associated with the requested simulation. A second user that matches the information associated with the requested simulation can have a similarity among one or more characteristics (e.g., size, preference, the like, or any combination thereof) with the information associated with the requested simulation that exceeds a predetermined similarity threshold. The similarity threshold can be configurable by a user (e.g., the first user or the second user).

In some embodiments, the first sending module 430 is configured to send to the second user a second request to operate the simulation. The second request to operate the simulation can relate to the object (e.g., the object associated with the first request to operate the simulation). The second request to operate the simulation can include the information associated with the first request to operate the simulation (e.g., simulation requirement information).

In some embodiments, the second receiving module 440 is configured to receive a result of the simulation. For example, the second receiving module 440 is configured to receive a result of the simulation submitted by one or more second users. In the event that a second user has accepted the second request to operate the simulation, the second receiving module 440 receives the simulation result submitted by the second user and obtained from subjecting the object to the operating simulation in accordance with the simulation requirement information.

In some embodiments, the second sending module 450 is configured to send the result of the simulation to the said first user. The second sending module 450 can send the result of the simulation to the first user in response to the second receiving module 440 receiving the result of the simulation.

In some embodiments, the communication linking module 460 is configured to establish a communication link between the first user and the second user in the event that a communication request submitted by the first user is received.

In some embodiments, similar to the user searching module 320 illustrated in FIG. 3, the user searching module 420 can include a user information searching sub-module, an assessing sub-module, or the like.

In some embodiments, the user information searching sub-module can include a first searching sub-module, a second searching sub-module, a third searching sub-module, a fourth searching sub-module, the like, or any combination thereof.

FIG. 5 is a structural block diagram of a system of operating a simulation system of objects according to various embodiments of the present application.

Referring to FIG. 5, a system 500 for operating a simulation of an object is provided. In some embodiments, the system 500 implements a method, such as method 100 illustrated in FIG. 1A, method 121 illustrated in FIG. 1B, or the like. In some embodiments, the system 500 implements the device 300 illustrated in FIG. 3. For example, the device 300 can be implemented as the server 530 in the system 500 illustrated in FIG. 5.

As illustrated in FIG. 5, the system 500 includes a first client 510, a second client 520, and a server 530. In some embodiments, the system 500 includes a network 540 over which the first client 510, the second client 520, the server 530, or any combination thereof, communicate. In some embodiments, the first user logs in to the server 530 (e.g., a service or website associated with the server 530) via the first client 510. In some embodiments, the second user logs in to the server 530 (e.g., a service or website associated with the server 530) via the second client 520.

The server 530 can include a first receiving module, a user searching module, a first sending module, a second receiving module, and a second sending module.

In some embodiments, the first receiving module is implemented using the first receiving module 310 of FIG. 3. In some embodiments, the first receiving module is configured to receive an object first operating simulation request submitted by a first user. For example, the first receiving module receives the first request to operate the simulation. The first receiving module can receive information associated with the first request to operate the simulation. The first request to operate the simulation can include the information associated with the first request to operate the simulation (e.g., simulation requirement information). The first request to operate the simulation can relate to a business subject. For example, the first request to operate the simulation can identify an object subject to the request to operate the simulation.

In some embodiments, the user searching module is implemented using the user searching module 320 of FIG. 3. In some embodiments, the user searching module is configured to search for a second user matching the information associated with the first request to operate the simulation (e.g., simulation requirement information). The user searching module can query a database for one or more matching second users. In some embodiments, in response to the first receiving module receiving a request to operate a simulation from a first user, the user searching module searches for a second user matching the information associated with the requested simulation (e.g., that is included with the request to operate the requested simulation). For example, the user searching module can search for a second user having characteristics that match the information associated with the requested simulation. A second user that matches the information associated with the requested simulation can have a similarity among one or more characteristics (e.g., size, preference, the like, or any combination thereof) with the information associated with the requested simulation that exceeds a predetermined similarity threshold. The similarity threshold can be configurable by a user (e.g., the first user or the second user).

In some embodiments, the first sending module is implemented using the first sending module 330 of FIG. 3. In some embodiments, the first sending module is configured to send to the second user a second request to operate the simulation. The second request to operate the simulation can relate to the object (e.g., the object associated with the first request to operate the simulation). The second request to operate the simulation can include the information associated with the first request to operate the simulation (e.g., simulation requirement information).

In some embodiments, the second receiving module is implemented using the second receiving module 340 of FIG. 3. In some embodiments, the second receiving module is configured to receive a result of the simulation. For example, the second receiving module is configured to receive a result of the simulation submitted by one or more second users. In the event that a second user has accepted the second request to operate the simulation, the second receiving module receives the simulation result submitted by the second user and obtained from subjecting the object to the operating simulation in accordance with the simulation requirement information.

In some embodiments, the second sending module is implemented using the second sending module 350 of FIG. 3. In some embodiment, the second sending module is configured to send the result of the simulation to the first user. The second sending module can send the result of the simulation to the first user in response to the second receiving module receiving the result of the simulation.

In some embodiments, the first client 510 includes a first submitting module and a third receiving module.

In some embodiments, the first submitting module of the first client 510 is configured to submit a first request to operate a simulation. For example, the first submitting module can submit a request to operate a simulation of an object. The first submitting module can submit the request to operate the simulation to the server 530. The request to operate the simulation submitted by the first submitting module can include information associated with the request to operate the simulation (e.g., simulation requirement information).

In some embodiments, the third receiving module of the first client 510 is configured to receive the result of the simulation. The third receiving module can receive the result of the simulation that is sent from the server.

In some embodiments, the second client 520 includes a fourth receiving module and a second submitting module.

In some embodiments, the fourth receiving module of the second client 520 is configured to receive a second request to operate the simulation. The fourth receiving module can receive the second request to operate the simulation of the object. The fourth receiving module can receive the second request to operate the simulation sent by said server. The second request to operate the simulation can include information associated with the request to operate the simulation (e.g., simulation requirement information).

In some embodiments, the second submitting module is configured to submit the result of the simulation to the server. For example, in the event that the second user has accepted the second request to operate the simulation, the second submitting module can receive a result of the simulation from the second user and the second submitting module can send the result of the simulation to the server. The result of the simulation can be obtained from subjecting the object to the operating simulation in accordance with the information associated with the request to operate the simulation (e.g., the simulation requirement information).

In some embodiments, the information associated with the requested simulation (e.g., the simulation requirement information) includes operating simulation user gender information, said object parameter information, simulation user quantity information, simulation location information, simulation authorized parameter information, the like, or any combination thereof.

In some embodiments, the object parameter information includes product type information, brand information, product number information, category information, size information, the like, or any combination thereof.

In some embodiments, the second user has user information corresponding thereto. In some embodiments, the user information corresponding to a particular user includes gender information, body shape information, activity location information, the like, or any combination thereof. In some embodiments the second user registers the user information corresponding to the second user when registering an account (e.g., with the server).

In some embodiments, the second user body shape information includes height information, weight information, chest/waist/hips information, shoulder width information, arm length information, leg length information, leg size information, head size information, the like, or any combination thereof.

In some embodiments, the user searching module of the server 530 can include a user information searching sub-module and an assessing sub-module.

In some embodiments, the user information searching sub-module is configured to search for user information matching the information associated with the request to operate the simulation (e.g., simulation requirement information).

In some embodiments, the assessing sub-module is configured to assess whether the second user corresponds to a second user matching the information associated with the request to operate the simulation (e.g., the simulation requirement information). For example, the assessing sub-module can assess whether the second user corresponds to a second user matching the simulation requirement information upon finding the user information of a second user.

In some embodiments, the user information searching sub-module can include a first searching sub-module, a second searching sub-module, a third searching sub-module, a fourth searching sub-module, the like, or any combination thereof.

In some embodiments, the first searching sub-module is configured to search for gender information of a second user matching user gender information for the simulation operation. For example, the first searching sub-module searches for gender information of a second user that matches gender information included in the information associated with the first request to operate the simulation.

In some embodiments, the second searching sub-module is configured to search for a body shape range adapted to the object parameter information. For example, the second searching sub-module searches for a body shape range matching the information associated with the first request to operate the simulation.

In some embodiments, the third searching sub-module is configured to search for body shape information within the body shape range.

In some embodiments, the fourth searching sub-module is configured to search for activity location information matching the simulation location information. For example, the fourth searching sub-module searches for activity location information matching the information associated with the first request to operate the simulation (e.g., location information associated with the requested simulation).

In some embodiments, the result of simulation can include simulation picture information, simulation text information, simulation audio information, simulation video information, the like, or any combination thereof.

FIG. 6 is a structural block diagram of a system for operating a simulation system of objects according to various embodiments of the present application.

Referring to FIG. 6, a system 600 for operating a simulation of an object is provided. In some embodiments, the system 600 implements a method, such as method 200 illustrated in FIG. 2, or the like. In some embodiments, the system 600 implements the device 400 illustrated in FIG. 4. For example, the device 400 can be implemented as the server 630 in the system 600 illustrated in FIG. 6.

As illustrated in FIG. 6, the system 600 includes a first client 610, a second client 620, and a server 630. In some embodiments, the system 600 includes a network 640 over which the first client 610, the second client 620, the server 630, or any combination thereof, communicate. In some embodiments, the first user logs in to the server 630 (e.g., a service or website associated with the server 630) via the first client 610. In some embodiments, the second user logs in to the server 630 (e.g., a service or website associated with the server 630) via the second client 620.

The server 630 can include a first receiving module, a user searching module, a first sending module, a second receiving module, a second sending module, and a communication linking module.

In some embodiments, the first receiving module is implemented by the first receiving module 410 illustrated in FIG. 4. The first receiving module is configured to receive an object first operating simulation request submitted by a first user. For example, the first receiving module receives the first request to operate the simulation. The first receiving module can receive information associated with the first request to operate the simulation. The first request to operate the simulation can include the information associated with the first request to operate the simulation (e.g., simulation requirement information). The first request to operate the simulation can relate to a business subject. For example, the first request to operate the simulation can identify an object subject to the request to operate the simulation.

In some embodiments, the user searching module is implemented by the user searching module 420 illustrated in FIG. 4. In some embodiments, the user searching module is configured to search for a second user matching the information associated with the first request to operate the simulation (e.g., simulation requirement information). The user searching module can query a database for one or more matching second users. In some embodiments, in response to the first receiving module receiving a request to operate a simulation from a first user, the user searching module searches for a second user matching the information associated with the requested simulation (e.g., that is included with the request to operate the requested simulation). For example, the user searching module can search for a second user having characteristics that match the information associated with the requested simulation. A second user that matches the information associated with the requested simulation can have a similarity among one or more characteristics (e.g., size, preference, the like, or any combination thereof) with the information associated with the requested simulation that exceeds a predetermined similarity threshold. The similarity threshold can be configurable by a user (e.g., the first user or the second user).

In some embodiments, the first sending module is implemented by the first sending module 430 illustrated in FIG. 4. In some embodiments, the first sending module is configured to send to the second user a second request to operate the simulation. The second request to operate the simulation can relate to the object (e.g., the object associated with the first request to operate the simulation). The second request to operate the simulation can include the information associated with the first request to operate the simulation (e.g., simulation requirement information).

In some embodiments, the second receiving module is implemented by the second receiving module 440 illustrated in FIG. 4. In some embodiments, the second receiving module is configured to receive a result of the simulation. For example, the second receiving module is configured to receive a result of the simulation submitted by one or more second users. In the event that a second user has accepted the second request to operate the simulation, the second receiving module receives the simulation result submitted by the second user and obtained from subjecting the object to the operating simulation in accordance with the simulation requirement information.

In some embodiment, the second sending module is implemented by the second sending module 450 illustrated in FIG. 4. In some embodiments, the second sending module is configured to send the result of the simulation to the said first user. The second sending module can send the result of the simulation to the first user in response to the second receiving module receiving the result of the simulation.

In some embodiments, the communication linking module is implemented by the communication linking module 460 illustrated in FIG. 4. In some embodiments, the communication linking module is configured to establish a communication link between the first user and the second user in the event that a communication request submitted by the first user is received.

In some embodiments, the first client 610 includes a first submitting module, a third receiving module, and a first communication module.

In some embodiments, the first submitting module of the first client 610 is configured to submit a first request to operate a simulation. For example, the first submitting module can submit a request to operate a simulation of an object. The first submitting module can submit the request to operate the simulation to the server 630. The request to operate the simulation submitted by the first submitting module can include information associated with the request to operate the simulation (e.g., simulation requirement information).

In some embodiments, the third receiving module of the first client 610 is configured to receive the result of the simulation. The third receiving module can receive the result of the simulation that is sent from the server.

In some embodiments, the first communication module is configured to establish a connection with the second user (e.g., via the server 630, the network 640, or directly with the second client 620).

In some embodiments, the second client 620 includes a fourth receiving module, a second submitting module, and a second communication module.

In some embodiments, the fourth receiving module of the second client 620 is configured to receive a second request to operate the simulation. The fourth receiving module can receive the second request to operate the simulation of the object. The fourth receiving module can receive the second request to operate the simulation sent by said server. The second request to operate the simulation can include information associated with the request to operate the simulation (e.g., simulation requirement information).

In some embodiments, the second submitting module is configured to submit the result of the simulation to the server. For example, in the event that the second user has accepted the second request to operate the simulation, the second submitting module can receive a result of the simulation from the second user and the second submitting module can send the result of the simulation to the server. The result of the simulation can be obtained from subjecting the object to the operating simulation in accordance with the information associated with the request to operate the simulation (e.g., the simulation requirement information).

In some embodiments, the second communication module is configured to establish a connection with the first user (e.g., via the server 630, the network 640, or directly with the first client 610).

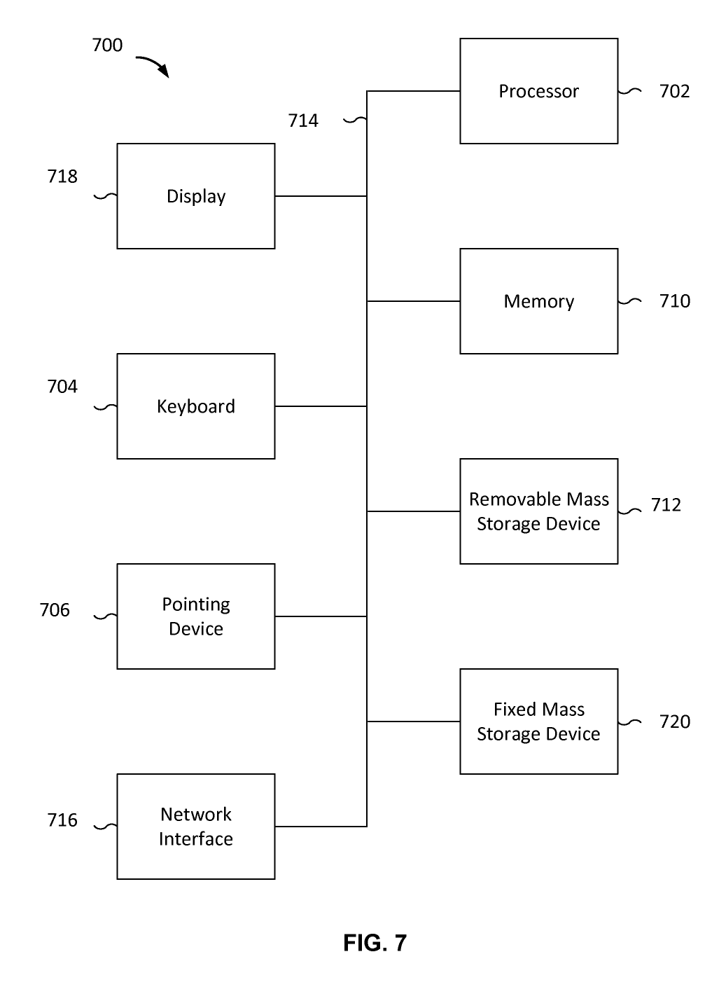

FIG. 7 is a functional diagram of a computer system for operating a simulation system of objects according to various embodiments of the present disclosure.

Referring to FIG. 7, a computer system 700 for operating a simulation system. As will be apparent, other computer system architectures and configurations can be used to implement video calls. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718).

Processor 702 is coupled bi-directionally with memory 710, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data, and objects used by the processor 702 to perform its functions (e.g., programmed instructions). For example, memory 710 can include any suitable computer-readable storage media, described below, depending on whether, for example, data access needs to be bi-directional or uni-directional. For example, processor 702 can also directly and very rapidly retrieve and store frequently needed data in a cache memory (not shown).

A removable mass storage device 712 provides additional data storage capacity for the computer system 700, and is coupled either bi-directionally (read/write) or uni-directionally (read only) to processor 702. For example, storage 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storage device 712 and fixed mass storage 720 generally store additional programming instructions, data, and the like that typically are not in active use by the processor 702. It will be appreciated that the information retained within mass storage device 712 and fixed mass storage 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

The modules described above can be implemented as software components executing on one or more general purpose processors, as hardware such as programmable logic devices, and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Finally, please note that in the present document relational terms such as “first” and “second” are employed only for the purpose of differentiating one thing or operation from another thing or operation without necessarily requiring or implying that any actual such relationship or sequence exists between these things or operations. Moreover, the term “comprise” or “contain” or any of their variants are to be taken in their non-exclusive sense. Thus, processes, methods, physical objects, or terminal equipment that comprise a series of elements not only comprise those elements, but also comprise other elements that have not been explicitly listed or elements that are intrinsic to such processes, methods, merchandise, or terminal equipment. In the absence of further limitations, elements that are limited by the phrase “comprises a(n) . . . ” do not exclude the existence of additional identical elements in processes, methods, physical objects, or terminal equipment that comprise said elements.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. An method comprising:
receiving, from a first user, a first request to operate a simulation of an object, wherein the first request to operate the simulation includes requirement information pertaining to the simulation of the object;
searching, among a plurality of users, for a second user based at least in part on the information associated with the first request to operate the simulation;
sending, to the second user, a second request to operate the simulation associated with the object;
receiving, from the second user, a result of the simulation in accordance with the second request to operate the simulation; and
sending, to the first user, the result of the simulation.

2. The method of claim 1, further comprising:
receiving, from the first user, a communication request; and
in the event that the communication request is received from the first user, establishing a communication link between the first user and the second user.

3. The method of claim 1, wherein the information associated with the first request to operate the simulation includes one or more of:
operating simulation user gender information, object parameter information, simulation user quantity information, simulation location information, or simulation authorized parameter information.

4. The method of claim 3, wherein object parameter information comprises one or more of:
product type information, brand information, product number information, category information, and size information.

5. The method of claim 1, wherein the searching for the second user based at least in part on the information associated with the first request to operate the simulation includes searching user information of the second user, wherein user information comprises one or more of:
gender information, body shape information, or activity location information.

6. The method of claim 5, wherein the body shape information of the second user comprises one or more of:
height information, weight information, chest/waist/hips information, shoulder width information, arm length information, leg length information, leg size information, or head size information.

7. The method of claim 5, wherein the searching for the second user based at least in part on the information associated with the first request to operate the simulation comprises:
searching for user information matching simulation requirement information, wherein at least part of the simulation requirement information is included in the information associated with the first request to operate the simulation.

8. The method of 7, wherein the searching for user information matching the simulation requirement information comprises one or more of:
searching for gender information of the second user matching user gender information associated with the first request to operate the simulation;
searching for a body shape range adapted to object parameter information associated with the first request to operate the simulation;
searching for body shape information within the body shape range; and
searching for activity location information matching simulation location information associated with the first request to operate the simulation.

9. The method of claim 1, wherein the result of the simulation comprises one or more of:
simulation image information, simulation text information, simulation audio information, or simulation video information.

10. A device comprising:
at least one processor configured to:
receive, from a first user, a first request to operate a simulation, wherein the first request to operate the simulation has information associated therewith, the information associated with the first request to operate the simulation including an indication of an object;
search for a second user based at least in part on the information associated with the first request to operate the simulation;
send, to the second user, a second request to operate the simulation associated with the object;
receive, from the second user, a result of the simulation in accordance with the second request to operate the simulation; and
send, to the first user, the result of the simulation; and
a memory coupled with the at least one processor and configured to provide the at least one processor with instructions.

11. The device of claim 10, wherein the at least one processor is further configured to establish a communication link between the first user and the second user in the event that a communication request is received from the first user.

12. The device of claim 10, wherein the information associated with the first request to operate the simulation includes one or more of:
operating simulation user gender information, object parameter information, simulation user quantity information, simulation location information, and simulation authorized parameter information.

13. The device of claim 12, wherein object parameter information comprises one or more of:
product type information, brand information, product number information, category information, and size information.

14. The device of claim 10, wherein the at least one processor is configured to search for the second user based at least in part on user information of the second user, wherein the user information comprises one or more of:
gender information, body shape information, and activity location information.

15. The device of claim 14, wherein the body shape information of the second user comprises one or more of:
height information, weight information, chest/waist/hips information, shoulder width information, arm length information, leg length information, leg size information, and head size information.

16. The device of claim 14, wherein the at least one processor is further configured to:
search for user information matching simulation requirement information, wherein at least part of the simulation requirement information is included in the information associated with the first request to operate the simulation.

17. The device of claim 16, wherein the at least one processor is further configured to:
search gender information of the second user matching user gender information associated with the first request to operate the simulation;
search for a body shape range adapted to object parameter information associated with the first request to operate the simulation;
search for body shape information within the body shape range; and
search for activity location information matching simulation location information associated with the first request to operate the simulation.

18. The device of claim 10, wherein the result of the simulation comprises one or more of:
simulation image information, simulation text information, simulation audio information, and simulation video information.

19. A system comprising a server, a first client, and a second client, a first user logging in at the first client, and a second user logging in at the second client;
wherein the server comprises:
at least one processor configured to:
receive, from the first user, a first request to operate a simulation, wherein the first request to operate the simulation has information associated therewith, the information associated with the first request to operate the simulation including an indication of an object;
search for the second user based at least in part on the information associated with the first request to operate the simulation;
send, to the second user, a second request to operate the simulation associated with the object;
receive, from the second user, a result of the simulation in accordance with the second request to operate the simulation; and
send, to the first user, the result of the simulation; and
a memory coupled with the at least one processor and configured to provide the at least one processor with instructions;
wherein the first client comprises:
at least one processor configured to:
submit the first request to operate the simulation; and
receive the result of the simulation sent from the server; and
a memory coupled with the at least one processor and configured to provide the at least one processor with instructions; and
wherein the second client comprises:
at least one processor configured to:
receive the second request to operate the simulation associated with the object sent by said server, wherein the second request to operate the simulation comprises information associated with the first request to operate the simulation; and
submit the result of the simulation to the server; and
a memory coupled with the at least one processor and configured to provide the at least one processor with instructions.

20. The system of claim 19, wherein the at least one processor of the server is further configured to establish a communication link between the first user and the second user in the event that a communication request is received from the first user;
the at least one processor of the first client is further configured to communicate with the second user using the communication link; and
the at least one processor of the second client is further configured to communicate with the first user using the communication link.

21. A computer program product embodied in a tangible non-transitory computer-readable storage medium and comprising computer instructions for:
receiving, from a first user, a first request to operate a simulation, wherein the first request to operate the simulation has information associated therewith, the information associated with the first request to operate the simulation including an indication of an object;
searching for a second user based at least in part on the information associated with the first request to operate the simulation;
sending, to the second user, a second request to operate the simulation associated with the object;
receiving, from the second user, a result of the simulation in accordance with the second request to operate the simulation; and
sending, to the first user, the result of the simulation.
